(19) United States
(12) Patent Application Publication
(10) Pub. No.: US 2026/0008357 A1
(43) Pub. Date: Jan. 8, 2026

(54) SYSTEM AND METHOD FOR CONTROLLING DRIFT DRIVING OF ELECTRIC VEHICLE

(71) Applicants: Hyundai Motor Company, Seoul (KR); Kia Corporation, Seoul (KR)

(72) Inventors: Jiwon Oh, Hwaseong-si (KR); Ho Wook Lee, Hwaseong-si (KR); Jeong Soo Eo, Hwaseong-si (KR)

(73) Assignees: Hyundai Motor Company, Seoul (KR); Kia Corporation, Seoul (KR)

(21) Appl. No.: 18/967,737

(22) Filed: Dec. 4, 2024

(30) Foreign Application Priority Data
Jul. 5, 2024 (KR) 10-2024-0088855

(51) Int. Cl. B60L 15/20

(52) U.S. Cl. CPC B60L 15/2036; B60L 2240/423; B60L 2250/28; B60L 2260/20

(57) ABSTRACT

Disclosed is a drive system torque control apparatus of an electric vehicle including a controller configured to generate torque commands to apply a driving torque to rear wheels to control the vehicle in a drift driving state, based on a demand torque, and front and rear wheel motors configured such that operation thereof is controlled depending on the torque commands generated by the controller to output torques to drive the vehicle, wherein the controller generates a rear wheel torque command having a torque value in a driving direction based on the demand torque, and a front wheel torque command having a torque value in a regenerative braking direction, and allows the vehicle to drift by a regenerative braking torque by the front wheel motor and the driving torque by the rear wheel motor depending on the generated front and rear wheel torque commands.

### CROSS-REFERENCE TO RELATED APPLICATION

This application claims under 35 U.S.C. § 119(a) the benefit of priority to Korean Patent Application No. 10-2024-0088855 filed on Jul. 5, 2024, the entire contents of which are incorporated herein by reference.

### BACKGROUND

### (a) Technical Field

The present disclosure relates to an apparatus and method for controlling drift driving that may easily generate the oversteer behavior of an electric vehicle and effectively manage oversteer when the drift mode of the electric vehicle is selected.

### (b) Background Art

The electric vehicle market is gradually expanding. In electric vehicles, the possibility of developing various new technologies has opened up, as most factors that acted as bottlenecks in technologies in internal combustion engine vehicles, such as responsiveness, fuel efficiency, and exhaust gas regulations, have been resolved.

Recently, moving away from the development paradigm of internal combustion engine vehicles, securing a unique selling point (USP) through expanded functions has become a crucial factor in the competitiveness of electric vehicles. Particularly, a drift mode, in which a driving force control strategy that ensures vehicle stability during normal driving, but rear wheel slip control intervention is stopped to allow a driver to freely drift in a rear wheel-oriented driving force state in which a rear wheel limited slip differential (LSD) is engaged and driving force is applied only to rear wheels only when the driver wants, is being developed as one representative USP factor that utilizes the characteristics of electric vehicles with a high degree of freedom in driving force control.

In electric vehicles, the drift mode is known technology. This technology employs a strategy to provide a driver with an environment in which rear wheel slip is easily induced by stopping tire slip control intervention and generating driving force exclusively from a rear wheel motor while engaging an electronic limited slip differential (e-LSD), in the case of an all-wheel drive (AWD) vehicle. In addition, for a rear-wheel drive (RWD) vehicle, the drift mode is implemented by stopping tire slip control intervention and engaging an e-LSD.

According to the known technology, rear wheel slip can be induced quite easily during execution of the drift mode alone. However, a torque large enough to exceed the gripping force of rear wheel tires is required, and due to the characteristics of electric vehicles that allow large torque fluctuations and magnitudes momentarily, it may be difficult for a driver to control vehicle behavior after slip is induced.

The above information disclosed in this Background section is provided solely to enhance understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an object of the present disclosure to provide a drive system torque control apparatus and method that may easily generate the oversteer behavior of an electric vehicle and effectively manage oversteer in the drift mode.

The objects of the present disclosure are not limited to the above-mentioned objects, and other objects not mentioned herein will be clearly understood by persons of ordinary skill in the art to which the present disclosure pertains (referred to as “those skilled in the art”) from the following description.

In one aspect, the present disclosure provides a drive system torque control apparatus for an electric vehicle. The system includes a controller configured to determine and generate torque commands to apply a driving torque to rear wheels to control the electric vehicle in a drift driving state, based on a demand torque for vehicle driving, and a front wheel motor and a rear wheel motor configured such that operation thereof is controlled depending on the torque commands generated and output by the controller to output torques to drive the electric vehicle in the drift driving state, wherein the controller generates a rear wheel torque command having a torque value in a driving direction for drift driving of the electric vehicle based on the demand torque, and a front wheel torque command having a torque value in a regenerative braking direction opposite to the driving direction, and allows the electric vehicle to drift using regenerative braking torque from the front wheel motor and driving torque from the rear wheel motor depending on the generated front wheel torque command and rear wheel torque command.

In a preferred embodiment, the controller may determine a sum of the torque values of the front wheel torque command in the regenerative braking direction and the rear wheel torque command in the driving direction during drift driving of the electric vehicle as a value that satisfies the demand torque.

In another preferred embodiment, the controller may determine the rear wheel torque command as a torque value in the driving direction corresponding to an accelerator pedal input value depending on operation of an accelerator pedal by a driver from the demand torque determined based on the accelerator pedal input value, may correct corrects the determined rear wheel torque command by adding an absolute value of the front wheel torque command to the determined rear wheel torque command, and may control the rear wheel motor using the corrected rear wheel torque command.

In yet another preferred embodiment, the controller may be set to generate the front wheel torque command in the regenerative braking direction for drift driving of the electric vehicle, only when a driver depresses the accelerator pedal and during a transient state in which the demand torque increases.

In yet another preferred embodiment, the controller may be set to generate only the rear wheel torque command in the driving direction for drift driving of the electric vehicle, when the magnitude of the demand torque remains constant, and to apply the torque by the rear wheel motor only to the rear wheels.

In yet another preferred embodiment, the controller may determine the front wheel torque command in the regenerative braking direction as a torque value corresponding to a slope of the demand torque.

In a further preferred embodiment, the controller may be set to determine the torque value of the front wheel torque command as a smaller value as the slope of the demand torque decreases, and to determine the torque value of the front wheel torque command as a larger value as the slope of the demand torque increases.

In another further preferred embodiment, the controller may be set to determine the front wheel torque command in the regenerative braking direction using a value obtained by applying a low-pass filter or a high-pass filter to the demand torque.

In yet another further preferred embodiment, the controller may determine the front wheel torque command as a torque value obtained by subtracting the demand torque from a low-pass filter-applied torque obtained by applying the low-pass filter to the demand torque.

In yet another further preferred embodiment, the controller may correct the rear wheel torque command determined from the demand torque by adding a torque, obtained by subtracting the low-pass filter-applied torque from the demand torque, to the rear wheel torque command, and may control the rear wheel motor using the corrected rear wheel torque command.

In yet another preferred embodiment, the controller may determine the front wheel torque command as a torque value obtained by multiplying a torque value, obtained by subtracting the demand torque from a high-pass filter-applied torque, obtained by applying the high-pass filter to the demand torque, by −1, or a torque value obtained by subtracting the high-pass filter-applied torque from the demand torque.

In yet another preferred embodiment, the controller may correct the rear wheel torque command determined from the demand torque by adding a torque, obtained by subtracting the demand torque from the high-pass filter-applied torque, to the rear wheel torque command, and may control the rear wheel motor using the corrected rear wheel torque command.

In yet another preferred embodiment, the drive system torque control apparatus may further include an interface configured to provide a user interface configured to allow a user to adjust and set a size or a level of a setting variable configured to determine a magnitude of the regenerative braking torque by the front wheel motor and an application maintenance time of the regenerative braking torque, and the interface may be provided to adjust and set a time constant of the low-pass filter or the high-pass filter as the setting variable.

In yet another preferred embodiment, the drive system torque control apparatus may further include an interface configured to provide a user interface configured to allow a user to adjust and set a size or a level of a setting variable configured to determine a magnitude of the regenerative braking torque by the front wheel motor and an application maintenance time of the regenerative braking torque,

In another aspect, the present disclosures provides a drive system torque control method of an electric vehicle including determining and generating, by a controller, torque commands to apply a driving torque to rear wheels to control the electric vehicle in a drift driving state based on a demand torque for vehicle driving, and controlling, by the controller, driving of a front wheel motor and a rear wheel motor to output torques to drive the electric vehicle in the drift driving state depending on the generated torque commands, wherein the controller generates a rear wheel torque command having a torque value in a driving direction for drift driving of the electric vehicle based on the demand torque, and a front wheel torque command having a torque value in a regenerative braking direction opposite to the driving direction, and enabling the electric vehicle to drift through regenerative braking torque from the front wheel motor and driving torque from the rear wheel motor.

Other aspects and preferred embodiments of the disclosure are discussed below.

The above and other features of the disclosure are discussed below.

### BRIEF DESCRIPTION OF THE DRAWINGS

The above and other features of the present disclosure will now be described in detail with reference to exemplary embodiments illustrated in the accompanying drawings which are given hereinbelow by way of illustration only, and thus are not limitative of the present disclosure, and wherein:

FIG. 1A and FIG. 1B are graphs illustrating the principle of reverse torque distribution control between front and rear wheels for implementing a drift mode according to the present disclosure;

FIG. 2 is a block diagram showing the configuration of an apparatus for performing a drive system torque control process according to the present disclosure;

FIG. 3A and FIG. 3B are graphs comparatively illustrating an example in which reverse torque distribution between front and rear wheels is always performed, and an example in which the reverse torque distribution between the front and rear wheels is performed only when a vehicle is accelerated, according to the present disclosure;

FIG. 4A and FIG. 4B are graphs comparatively illustrating an example in which the sum of a front wheel torque and a rear wheel torque does not satisfy a demand torque, and an example in which the sum of the front wheel torque and the rear wheel torque satisfies the demand torque, according to the present disclosure;

FIG. 5 is a graph illustrating a front wheel torque command, a demand torque, and a filter-applied torque command according to one embodiment of the present disclosure;

FIG. 6 is a graph illustrating changes in reversely distributed torque applied to front wheels depending on a time constant of a low-pass filter according to the present disclosure; and

FIG. 7 is a diagram illustrating a user interface (UI) for setting drift sensitivity according to one embodiment of the present disclosure.

It should be understood that the appended drawings are not necessarily to scale, and present a simplified representation of various preferred features illustrative of the basic principles of the disclosure. The specific design features of the present disclosure as disclosed herein, including, dimensions, orientations, locations, and shapes, will be determined in part by the particular intended application and use environment.

In the figures, reference numbers refer to the same or equivalent parts of the present disclosure across the various figures.

### DETAILED DESCRIPTION

Hereinafter, detailed reference will be made to various embodiments of the present disclosure, examples of which are illustrated in the accompanying drawings and described below. Specific structural or functional descriptions in embodiments of the present disclosure set forth in the description which follows will be exemplarily given to describe the embodiments of the present disclosure, and the present disclosure may be embodied in many alternative forms. Further, it will be understood that the present disclosure should not be construed as being limited to the embodiments set forth herein, and the embodiments of the present disclosure are provided only to completely disclose the disclosure and cover modifications, equivalents or alternatives which come within the scope and technical range of the disclosure.

In the following description of the embodiments, terms, such as “first” and “second”, are used solely to describe various elements and should not be construed as limiting. These terms are used only to distinguish one element from other elements. For example, a first element described herein may be referred to as a second element, and vice versa, without departing from the scope of the disclosure.

When an element or layer is referred to as being “connected to” or “coupled to” another element or layer, it may be directly connected or coupled to the other element or layer, or intervening elements or layers may be present. In contrast, when an element or layer is referred to as being “directly connected to” or “directly coupled to” another element or layer, there may be no intervening elements or layers present. Other terms describing relationships between elements should be interpreted similarly, e.g., “between” versus “directly between,” “adjacent” versus “directly adjacent,” etc.

Wherever possible, the same reference numbers will be used throughout the drawings to refer to the same or like parts. The terminology used herein is solely for describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, operations, operations, elements, components, and/or combinations thereof, but do not preclude the presence or addition of one or more other features, integers, operations, operations, elements, components, and/or combinations thereof.

The present disclosure relates to an apparatus and method for controlling drift driving of an electric vehicle that may perform may reverse torque distribution control between front and rear wheels to effectively control the oversteer behavior of the electric vehicle while facilitating occurrence of oversteer in the drift mode of the electric vehicle.

The present disclosure proposes a method for easily inducing oversteer behavior in a vehicle by utilizing longitudinal load transfer during a torque fluctuation transient state. Particularly, the present disclosure proposes a method that utilizes regenerative braking force of front wheels to generate linear oversteer starting characteristics corresponding to a linear torque increase input rather than forcibly increasing a rear wheel torque to start oversteer.

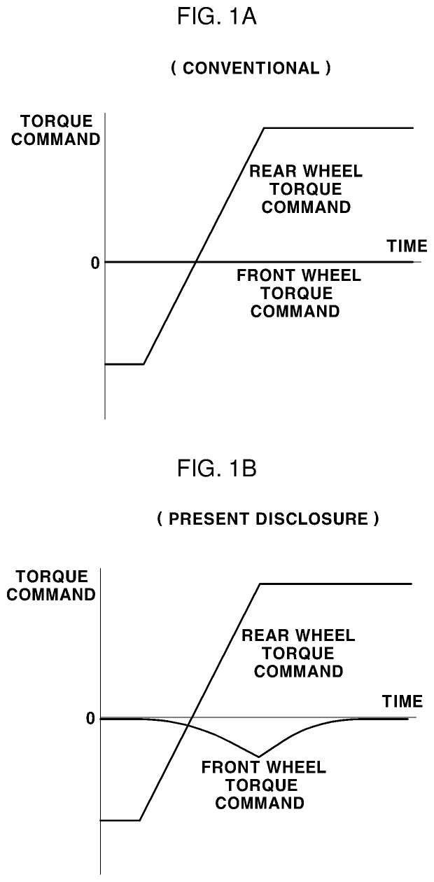

FIG. 1A and FIG. 1B are graphs illustrating the principle of reverse torque distribution control between front and rear wheels for implementing a drift mode according the present disclosure, and specifically, FIG. 1A illustrates a conventional torque distribution method, while FIG. 1B shows rear wheel and front wheel torque commands in the drift mode proposed by the present disclosure. In the conventional drift mode, as shown in FIG. 1A, only the power of the rear wheels is used, and the power of the front wheels is suppressed. This method is effective in generating oversteer, but it is difficult to generate oversteer if there is no load transfer.

Accordingly, as shown in FIG. 1B, if a front wheel torque in the direction of regenerative braking is generated in a transient section where a demand torque increases, nosedown load transfer of a vehicle is induced and thereby making oversteer easy to achieve. However, since the degree of ease of occurrence of the above-described oversteer may be excessive, the present disclosure may provide a user interface (UI) that may adjust the overall regenerative braking amount applied to the front wheels in the transient state where the rear wheel torque increases tailored to the driver's preference. Further, in the present disclosure, a method of applying a filter to the demand torque may be used as a method that determines the front wheel regenerative braking amount in the transient state.

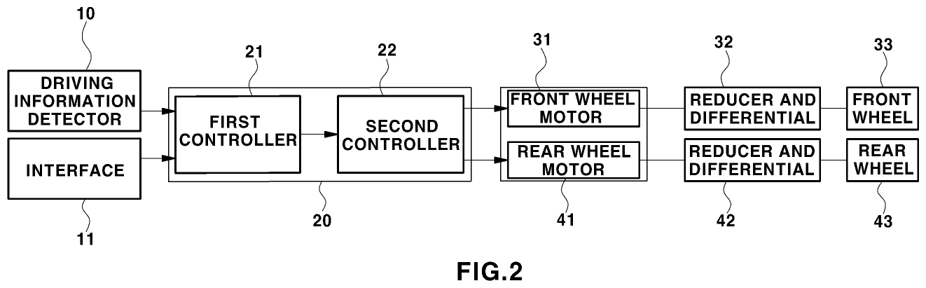

FIG. 2 is a block diagram showing the configuration of an apparatus for performing a drive system torque control process according to the present disclosure, and the configuration of the illustrated apparatus will be described as follows.

The present disclosure may be applied to a vehicle in which front wheels 33 and rear wheels 43 are driven by independent drive devices, respectively. Specifically, the present disclosure may be applied to a vehicle equipped with a front wheel drive device which applies torque to the front wheels 33, and a rear wheel drive device which applies torque to the rear wheels 43. Here, the front wheels 33 and rear wheels 43 are driving wheels connected to their respective drive devices, enabling the transmission of power from the drive devices.

In addition, the present disclosure may be applied to a vehicle in which both the front wheel drive device and the rear wheel drive device are motors. In the following description, a motor 31 serving as a front wheel drive device will be referred to as a “front wheel motor”, and a motor 41 serving as a rear wheel drive device will be referred to as a “rear wheel motor”.

As shown in this figure, the front wheel motor 31 is connected to the front wheels 33 through a reducer and differential 32 to transmit power, and the rear wheel motor 41 is connected to the rear wheels 43 through a reducer and differential 42 so as to be able to transmit power.

In the following description, a front wheel torque command and a rear wheel torque command are torque commands for respective axles (i.e., a front axle torque command and a rear axle torque command). These indicate the front wheel motor torque command, for the front wheel motor 31, and a rear wheel motor torque command, which is a torque command for the rear wheel motor 41.

Among motor torques, a torque in a vehicle acceleration direction and a torque in a motor driving direction are torques in the positive (+) direction, i.e., torques having positive (+) values. In the present disclosure, a braking torque includes a regenerative braking torque by the front wheel motor 31 and the rear wheel motor 41, and the regenerative braking torque is a torque in a vehicle deceleration direction, and is thus defined as a torque in the negative (−) direction, i.e., a torque having a negative (−) value.

If the torque values of the front wheel torque command and the rear wheel torque command, which are torque commands for the motors 31 and 41, are negative (−) values, these commands are regenerative braking torque commands for the corresponding motors, and a front wheel motor torque and a rear wheel motor torque having negative (−) values are torques in the vehicle deceleration direction, i.e., the motor regenerative braking direction.

Conversely, if the torque values of the front wheel torque command and the rear wheel torque command are positive (+) values, these commands are driving torque commands for the corresponding motors, and a front wheel motor torque and a rear wheel motor torque having positive (+) values are torques in the vehicle acceleration direction, i.e., the motor driving direction, which may be said to be torques that the corresponding motors must generate by the respective driving torque commands.

In the present disclosure, the drive system of the vehicle includes a front wheel drive system and a rear wheel drive system, and each of the front wheel drive system and the rear wheel drive system includes drive elements, such as a motor and driving wheels which drive the vehicle, a drive shaft between the motor and the driving wheels, a reducer and differential, an axle, etc.

That is, the front wheel drive system includes the front motor 31, the front wheels 33, a drive shaft (not shown) between the front motor 31 and the front wheels 33, the reducer and differential 32, and the axle (not shown), and the rear wheel drive system includes the rear motor 41, the rear wheels 43, a drive shaft (not shown) between the rear motor 41 and the rear wheels 43, the reducer and differential 42, and the axle (not shown).

Accordingly, in each drive system, a torque applied from the front wheel motor 31 or the rear wheel motor 41 may be transmitted to the front wheels 33 or the rear wheels 43 through the drive elements, such as the drive shaft, the reducer and differential 32 or 42, and the axle, and Conversely, torque from the front wheels 33 or rear wheels 43 can also be transmitted back to the front wheel motor 31 or rear wheel motor 41 through the same drive elements.

Further, although not shown in FIG. 1, a battery may be connected to the front wheel motor 31 and the rear wheel motor 41 via inverters enabling charging and discharging. The inverters may include a front wheel inverter (not shown) configured to drive and control the front wheel motor 31, and a rear wheel inverter (not shown) configured to drive and control the rear wheel motor 41.

In the electric vehicle, operation (driving and regenerative braking) of the front wheel motor 31 and the rear wheel motor 41 is controlled by torque commands generated by a controller 20. The controller 20 determines a demand torque based on vehicle driving information acquired by a driving information detector 10, and determines a front wheel torque and a rear wheel torque, which are torques distributed from the demand torque.

Thereafter, the controller 20 generates and outputs torque commands for the respective motors, i.e., a front wheel torque command and a rear wheel torque command, as torque commands for the respective motors to generate the front wheel torque and the rear wheel torque, using the determined front wheel torque rear wheel torque as command values.

In addition, the controller 20 controls operation of the front wheel motor 31 and the rear wheel motor 41 through the inverters based on the front wheel torque command and the rear wheel torque command. As described above, when command torques based on the front wheel torque command and the rear wheel torque command are torques in the positive (+) direction (torques having positive values), the front wheel torque command and the rear wheel torque command are driving torque commands, i.e., torque commands in the vehicle acceleration direction and the motor driving direction, and when the command torques based on the front wheel torque command and the rear wheel torque command are torques in the negative (−) direction (torques having negative values), the front wheel torque command and the rear wheel torque command are regenerative braking torque commands, i.e., torque commands in the vehicle deceleration direction and the regenerative braking direction.

The controller 20 in the present disclosure may include a first controller 21 which determines the demand torque required to drive the vehicle based on the vehicle driving information detected by the driving information detector 10, such as a driving input value input by a driver, or receives the demand torque from other controllers, such as an Advanced Driver Assistance System (ADAS) controller, and generates and outputs the front wheel torque command and the rear wheel torque command, which are torque commands for the respective motors (or the respective axles), based on the demand torque, and a second controller 22 controls the operation of the front wheel motor 31 and rear wheel motor 41 based on the torque commands from the first controller 21.

The first controller 21 may be a Vehicle Control Unit (VCU) which determines and generates a torque command required for vehicle driving in a typical vehicle. A method of determining a demand torque required to drive a vehicle from vehicle driving information and determining torque commands to control torques of drive systems including motors are known in the art, and a detailed description thereof will thus be omitted.

When the first controller 21 outputs the front wheel torque command and the rear wheel torque command, the second controller 22 receives the front and rear wheel torque commands and controls operation of the front wheel motor 31 and the rear wheel motor 41 through the front wheel inverter and the rear wheel inverter.

Thereby, a torque output by the front wheel motor 31 is applied to the front wheels 33 through the reducer and differential assembly 32 of the front wheel drive system, and a torque output by the rear wheel motor 41 is applied to the rear wheels 43 through the reducer and differential assembly 42 of the rear wheel drive system.

The second controller 22 may be a general Motor Control Unit (MCU) which controls operation of a drive motor through an inverter depending on a torque command output from a Vehicle Control Unit in an electric vehicle.

In the present disclosure, the vehicle driving information, such as the driving input value input by the driver to the controller 20, is information indicating a vehicle driving state, and may include sensor detection information detected by the driving information detector 10 and input to the controller 20 through a vehicle network.

The driving information detector 10 may include an accelerator position sensor (APS; not shown) which detects a driver's accelerator pedal input value (APS value, %), sensors (not shown) which detect drive system speeds, and a sensor (not shown) which detects a vehicle speed.

Here, the drive system speeds refer to the rotational speeds of the front wheel motor 31 and the rear wheel motor 41, which are drive motors, or rotation speeds of the drive wheels 33 and 43. The sensors which detect the drive system speeds, may be sensors which detect the rotation speeds of the respective motor 31 and 41, and may be general resolvers which detect the positions of rotors of the respective motors. Alternatively, drive system speeds may be detected by standard wheel speed sensors that measure the rotational speeds of drive wheels 33 and 43 (wheel speeds).

In addition, the sensor which detects the vehicle speed may also be a wheel speed sensor. Acquisition of vehicle speed information from a signal from the wheel speed sensor is well known in the art and will not be described in detail here.

As the vehicle driving information required for the controller 20 to determine and generate the demand torque and the torque commands, the driver's accelerator pedal input value (APS value, %), the rotation speeds of the motors 31 and 41, the rotation speeds of the drive wheels 33 and 43, and vehicle speed, as detected by the driving information detector 10. Further, the vehicle driving information may include information determined by the controller 20 by itself in a broad sense, and may further include information (for example, demand torque information) input to the controller 20 from other controllers (for example, the ADAS controller) in the vehicle through the vehicle network.

The drive system torque control apparatus according to one embodiment of the present disclosure may further include an interface 11. The interface 11 provides a user interface (hereinafter, referred to as a “UI”) configured to allow the driver to select on or off of the drift mode in the vehicle and adjust a setting value required for reverse torque distribution control between front and rear wheels. Any method enabling the driver to operate and input adjustments to the settings in the vehicle may serve as interface 11 without limitation.

For example, the interface 11 may include an operating device, such as a button or a switch provided in the vehicle, or an input device or a touchscreen of an audio, video and navigation (AVN) system.

Interface 11 may connect to controller 20 and may also include a display device alongside the input device. Accordingly, when the UI configured to allow the driver to adjust and change the setting value is displayed on the display device of the interface 11 by the controller 20, the driver may perform an input to adjust and change the setting value by operating the input device after confirming displayed information.

When the driver performs operation and input to adjust and change the setting value in the interface 11, the controller 20 may receive an electrical signal depending on the operation and input from the interface 11, may update the existing setting value as a new value adjusted and changed by the driver, and may store the updated value.

Although the above-described interface 11 is described as a device installed in the vehicle, as another example, the interface 11 may allow the driver to adjust and change the setting value through a mobile device. The mobile device must be capable of communicating with controller 20, using a known communication interface for connecting the two. Although a control subject is divided into the first controller 21 and the second controller 22 in the above description, a torque control process according to the present disclosure may be performed by one integrated control element instead of a plurality of controllers.

In this disclosure, the aforementioned multiple controllers and single integrated control element may be collectively referred to as controller 20, which executes the torque control process described below. In the following description, the first controller 21 and the second controller 22 will be collectively referred to as the controller 20.

The configuration of the apparatus for performing the drive system torque control process according to the present disclosure has been described above, and a drive system torque control process performed by the above-described apparatus will be descried below.

First, as one embodiment of the present disclosure, a method of performing reverse torque distribution between the front and rear wheels may be applied to facilitate oversteer of the vehicle in the drift mode.

In the present disclosure, the reverse torque distribution between the front and rear wheels means distribution and generation of a front wheel torque and a rear wheel torque so that the torque directions of the front wheels and the rear wheels are opposite. For example, if a torque in the driving direction is applied to the rear wheels, a torque in the regenerative braking direction, which is opposite to the driving direction, is applied to the front wheels. A torque having a positive (+) value and direction is applied to the rear wheels, and a torque having a negative (−) value and direction is applied to the front wheels.

In order to facilitate occurrence of oversteer of the vehicle, the lateral gripping force limit of the rear wheels is lowered compared to the lateral gripping force limit of the front wheels. As one of methods to achieve this effect, the longitudinal driving force of the rear wheels may be increased by causing the driver to apply force to an accelerator pedal using the output generation characteristics of a rear-wheel drive type, and in this case, the longitudinal driving force of the rear wheels increased by tire friction source characteristics reduces the lateral gripping force limit of the rear wheels.

Another method to reduce the lateral gripping force limit of the rear wheels involves using the vehicle's longitudinal load transfer. Nosedown (dive) or noseup (squat) of sprung mass occurs due to acceleration or deceleration of the vehicle, and at this time, the normal force of the front wheels and the normal force of the rear wheels change depending on the characteristics of a suspension system.

In general, when decelerating, nosedown of the vehicle occurs, and thus increases the normal force of the front wheels and decreases the normal force of the rear wheels. On the contrary, when accelerating, noseup of the vehicle occurs, and thus decreases the normal force of the front wheels and increases the normal force of the rear wheels. Since the gripping force limit of a vehicle wheel is proportional to the normal force, it may be seen that oversteer easily occurs when decelerating.

However, paradoxically, since driving force in the acceleration direction is applied to the rear wheels as the method of causing oversteer of the vehicle in the above-described general drift mode, corresponding longitudinal load transfer may occur when accelerating, and may thus increase the normal force of the rear wheels.

This may induce a vehicle behavior that runs counter to the purpose of the drift mode, which is to artificially generate vehicle oversteer quickly, and it may be difficult to induce oversteer until a large driving force sufficient to overcome an increment of the normal force of the rear wheels is applied.

Therefore, in the control method according the present disclosure, in driving force distribution in the drift mode, when the driver depresses the accelerator pedal, a torque corresponding to a driver's accelerator pedal input value (i.e., an accelerator pedal operation amount) may be applied to the rear wheels, and a regenerative braking torque may be applied to the front wheels through reverse distribution.

By applying the regenerative braking torque to the front wheels in this way, vehicle load transfer to the rear wheels may be prevented, and at this time, the driving torque of the rear wheels may contribute to reduction in the lateral gripping force limit of rear wheel tires by increasing the driving force thereof. This ensures that both the driving force of the rear wheel tires and the changes in the normal forces of the front and rear wheels facilitate oversteer.

Further, in one embodiment of the present disclosure, the above-described reverse torque distribution between the front and rear wheels may be set to be used only in the transient state of the demand torque depending on driver's accelerator pedal operation. It is desirable to create conditions that facilitate occurrence of oversteer when a driver's intention to induce oversteer is clear, but it is not desirable in terms of efficiency or performance to use the reverse torque distribution between the front and rear wheels in all situations.

This is because, once oversteer begins, the driver must control the vehicle's yaw angle to maintain the drift state, which requires linear acceleration and deceleration characteristics. In addition, if the reverse torque distribution between the front and rear wheels is always applied, acceleration performance is limited and power efficiency decreases since the front and rear wheel torques always have opposite signs.

Therefore, the reverse torque distribution between the front and rear wheels is used only in the transient state in which the demand torque changes depending on a driver's action of depressing the accelerator pedal, and the existing drift mode control, i.e., rear wheel-oriented torque generation (rear wheel-oriented driving force distribution), in which driving force is applied only to the rear wheels using the rear wheel motor, is maintained in a steady state in which the demand torque does not change.

In addition, the controller 20 may be set to distinguish between the transient state and the steady state based on the slope of the demand torque. Further, rather than dichotomously distinguishing whether to perform the reverse torque distribution between the front and rear wheels depending on the transient state and the steady state, the degree of the reverse torque distribution between the front and rear wheels may be determined in proportion to the slope of the demand torque. In other words, the degree of reverse torque distribution is adjusted such that a smaller slope of the demand torque indicates a steady state, while a larger slope indicates a transient state. In other words, it may be determined that, the smaller the slope of the demand torque, the smaller the magnitude of the regenerative braking torque applied to the front wheels is, and the larger the slope of the demand torque, the larger the magnitude of the regenerative braking torque applied to the front wheels is. Here, the magnitude of the torque means the magnitude of the absolute value of the torque.

Furthermore, the torque distribution ratio between the front and rear wheels may correspond to the slope of the demand torque, with torque distributed accordingly. In addition, since the purpose is to facilitate start of oversteer occurrence depending on the driver's intention when the oversteer behavior starts, it may be set to be determined to be in the transient state only when the demand torque increases, and conversely to be determined to be in the steady state when the demand torque decreases. Reverse torque distribution between the front and rear wheels, applying regenerative braking force to the front wheels, is performed only during the transient state. Further, assuming that the driver starts oversteer by depressing the accelerator pedal, the regenerative braking force may be applied to the front wheels through reverse distribution only when the driver operates the accelerator pedal and the demand torque is in the driving direction, and rear wheel-oriented torque generation, which is the existing drift mode control, may be maintained when the demand torque is in the regenerative braking direction.

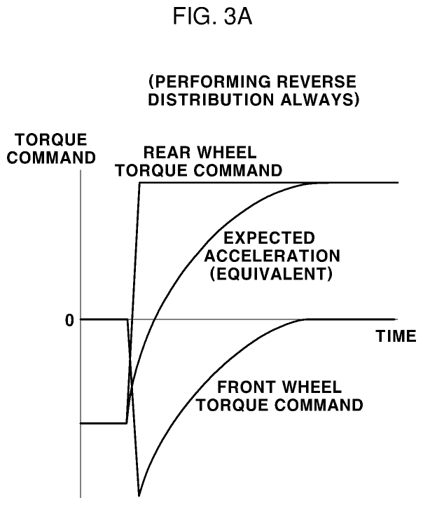

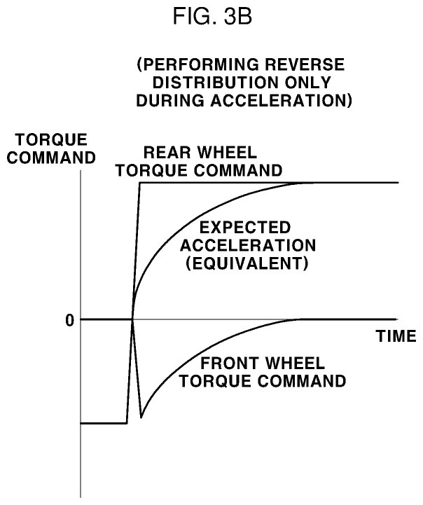

FIG. 3A and FIG. 3B are graphs comparatively illustrating an example in which the reverse torque distribution between the front and rear wheels is always performed, and an example in which the reverse torque distribution between the front and rear wheels is performed only when the vehicle is accelerated, and in the example in which the reverse torque distribution between the front and rear wheels is always performed, the regenerative braking torque, which is a negative torque, is applied to the front wheels by the reverse torque distribution between the front and rear wheels even when a vehicle acceleration (expected acceleration) has a negative (−) value, i.e. the vehicle is decelerated.

On the other hand, in the example in which the reverse torque distribution between the front and rear wheels is performed only when the vehicle is accelerated, the reverse torque distribution between the front and rear wheels is performed only when the vehicle acceleration has a positive (+) value, i.e., when the vehicle is actually accelerated, and thus, the regenerative braking torque, which is a negative (−) torque, is applied to the front wheels only when the vehicle is accelerated.

Additionally, one embodiment may apply a method that maintains the sum of the front and rear wheel torques. If the regenerative braking torque is applied to the front wheels through the reverse distribution while maintaining a rear-wheel generated torque at the time of behavior in the existing drift mode (in the event of rear wheel-oriented torque generation), the total acceleration torque between the front and rear wheels may decrease, and may thus result in an insufficient acceleration amount.

Accordingly, a method of compensatorily generating a torque equivalent to the regenerative braking torque applied to the front wheels from the rear wheels through the reverse torque distribution between the front and rear wheels may be applied, and at this time, the regenerative braking torque of the front wheels and the driving torque of the rear wheels may be determined so that the sum of the front wheel torque and the rear wheel torque is the same as the existing demand torque before applying the reverse torque distribution.

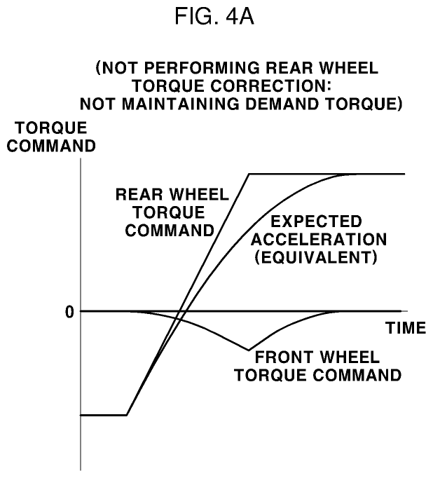

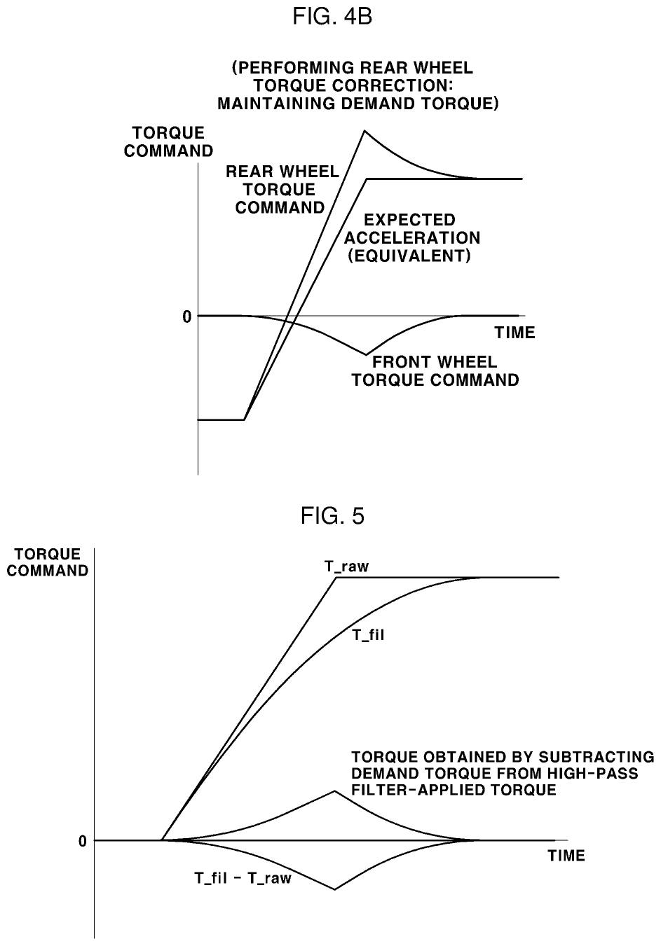

Specifically, torque correction may be performed by adding the absolute value of the front wheel regenerative braking torque (negative torque) to the rear wheel driving torque (positive torque), ensuring their sum matches the existing demand torque. Naturally, rear wheel torque correction is performed only within the limits of the rear wheels' maximum torque. The corrected rear wheel torque is capped at this maximum limit to prevent exceeding it. FIG. 4A and FIG. 4B are graphs comparatively illustrating an example in which the sum of the front wheel torque and the rear wheel torque does not satisfy the demand torque, and an example in which the sum of the front wheel torque and the rear wheel torque satisfies the demand torque. In both cases, the same regenerative braking torque is applied to the front wheels.

As illustrated, in the example in which the sum of the front wheel torque and the rear wheel torque does not satisfy the demand torque, since the regenerative braking torque in the opposite direction to the driving torque of the rear wheels is applied to the front wheels, the sum of the front wheel torque and the rear wheel torque does not satisfy the demand torque, and thus, the acceleration amount of the vehicle may be insufficient.

On the other hand, in the example in which the sum of the front wheel torque and the rear wheel torque satisfies the demand torque, rear wheel torque correction, in which a positive (+) torque corresponding to the absolute value of the regenerative braking torque applied to the front wheels is added to the rear wheel torque, which is a positive (+) torque, is performed.

Consequently, the sum of the front wheel torque and the rear wheel torque satisfies the demand torque in the existing drift mode, and the acceleration amount of the vehicle required by the driver may be obtained. At this time, the maximum value of the corrected rear wheel torque may be limited to the predetermined maximum limit torque of the rear wheels so that the corrected rear wheel torque does not exceed the maximum limit torque.

In one embodiment of the present disclosure, a method of calculating a reversely distributed torque applied to the front wheels when the reverse torque distribution control between the front and rear wheels in the drift mode is performed is described in more detail as follows.

In determination of the front wheel torque and the rear wheel torque through the reverse torque distribution between the front and rear wheels in the drift mode, a value obtained by applying a filter to the demand torque may be used. A low-pass filter (LPF) or high-pass filter (HPF) may serve as the filter.

That is, when a demand torque T_raw is determined based on real-time vehicle driving information detected by the driving information detector 10, the controller 20 determines a torque obtained by applying a low-pass filter (LPF) having a time constant τ (tau) to the demand torque T_raw, i.e., a low-pass filter-applied torque T_fil. Thereafter, a torque T_fil−T_raw obtained by subtracting the demand torque T_raw from the low-pass filter-applied torque T_fil may be determined as a front wheel torque, i.e., the regenerative braking torque command of the front wheels, among results of the reverse torque distribution.

Alternatively, as another method of producing the same result, the controller 20 may determine a torque obtained by applying a high-pass filter (HPF) having a time constant τ (tau) to the demand torque T_raw, i.e., a high-pass filter-applied torque, and may determine a value obtained by multiplying a torque, obtained by subtracting the demand torque from the high-pass filter-applied torque, by −1, or a torque obtained by subtracting the high-pass filter-applied torque from the demand torque as the reversely distributed torque applied to the front wheels, i.e., the regenerative braking torque command of the front wheels.

In addition, a torque T_raw−T_fil obtained by subtracting the low-pass filter-applied torque T_fil from the demand torque T_raw may be determined as a correction torque of the rear wheels to maintain the demand torque (the demand torque in the existing drift mode), which is the sum of the front wheel torque and the rear wheel torque.

Alternatively, a torque obtained by subtracting the demand torque T_raw from the high-pass filter-applied torque may be determined as the correction torque of the rear wheels to maintain the demand torque (the demand torque in the existing drift mode), which is the sum of the front wheel torque and the rear wheel torque.

In this case, in the existing drift mode, the demand torque T_raw is applied only to the rear wheels while the demand torque T_raw increases, but in the present disclosure, the correction torque is additionally applied to the rear wheels, and thus, “T_raw+correction torque of rear wheels=T_raw+(T_raw−T_fil)=2×T_raw−T_fil” becomes the rear wheel torque command. Here, the result of the sum of the front wheel torque and the rear wheel torque is “(T_fil−T_raw)+(2×T_raw−T_fil)=T_raw”.

FIG. 5 is a graph illustrating the front wheel torque command, the demand torque, and the filter-applied torque command according to one embodiment of the present disclosure, and in this case, “T_raw” indicates the demand torque in the drift mode and “T_fil” indicates the low-pass filter-applied torque.

As a result of the reverse torque distribution between the front and rear wheels, the front wheel torque, i.e., the regenerative braking torque of the front wheels, may be determined as the torque T_fil−T_raw obtained by subtracting the demand torque T_raw from the low-pass filter-applied torque T_fil.

Here, the rear wheel torque is determined as a torque obtained by subtracting the front wheel torque from the demand torque, i.e., “T_raw−(T_fil−T_raw)=2×T_raw−T_fil”. FIG. 5 also illustrates the torque obtained by subtracting the demand torque from the high-pass filter-applied torque, obtained by applying the high-pass filter to the demand torque T_raw, and a value obtained by multiplying this torque by −1 becomes the reversely distributed torque T_fil−T_raw applied to the front wheel torque.

In one embodiment, the driver can adjust the setting value for reverse torque distribution control using interface 11 in the vehicle. Here, the setting value may be a setting value related to drift sensitivity, and may be the size or level of a variable that may change the degree of ease of occurrence of oversteer compared to the known drift mode.

Specifically, the setting value may adjust variables affecting the reversely distributed torque during drift, such as its magnitude or the duration of its application to the front wheels.

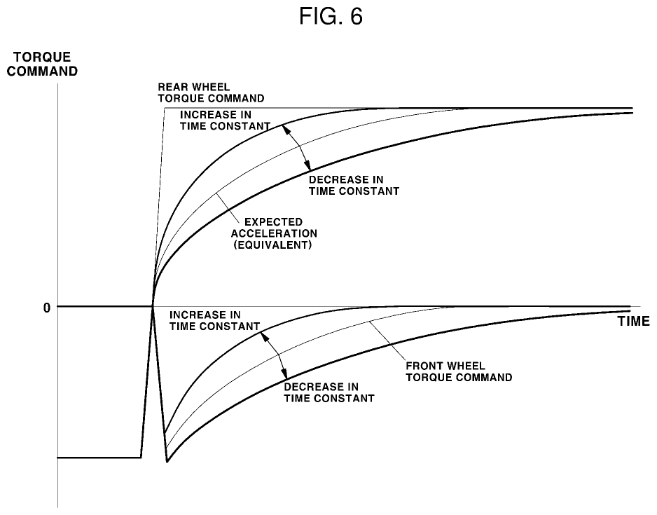

Here, the reversely distributed torque applied to the front wheels is a regenerative braking torque in opposite direction to the driving torque of the rear wheels during drift. Further, the maintenance time may be a time for which the reversely distributed torque is applied to the front wheels. Otherwise, since the magnitude of the reversely distributed torque applied to the front wheels changes while being applied (see FIG. 6), the maintenance time may be a time for which the transient state in which the reversely distributed torque applied to the front wheels changes is maintained.

Thus, one embodiment of this disclosure provides a user interface (UI) enabling the driver to adjust the ease of oversteer compared to standard drift mode by modifying the magnitude or maintenance time of the reversely distributed torque based on a preset or driver-adjusted setting value.

As an example of a method of implementing this, the driver may adjust or change the time constant of the above-described filter, for example, the time constant τ (tau) of the low-pass filter, to a desired value through the interface 11.

FIG. 6 shows how the reversely distributed torque applied to the front wheels varies with changes in the low-pass filter's time constant in this disclosure. In one embodiment of the present disclosure, the driver may adjust and change the time constant τ as the above setting value through the interface 11.

As shown in FIG. 6, as the time constant τ of the low-pass filter increases, the magnitude (the size of the absolute value) and the maintenance time of the reversely distributed torque applied to the front wheels increase, and as the time constant τ of the low-pass filter decreases, the magnitude and the maintenance time of the reversely distributed torque applied to the front wheels decrease.

Therefore, it is possible to proportionally select between a mode in which start of oversteer becomes easier but acceleration responsiveness is sacrificed (if rear wheel correction is not performed) by increasing the time constant τ, and a mode in which ease of start of oversteer is maintained to the extent in the known drift mode but acceleration responsiveness is not sacrificed by decreasing the time constant τ.

Alternatively, the driver can adjust the weight applied to the reversely distributed torque on the front wheels via interface 11. When the driver adjusts the weight, the controller 20 may correct the magnitude of the reversely distributed torque applied to the front wheels by multiplying the reversely distributed torque applied to the front wheels by the adjusted weight, and may generate and output the front wheel torque command with the corrected value.

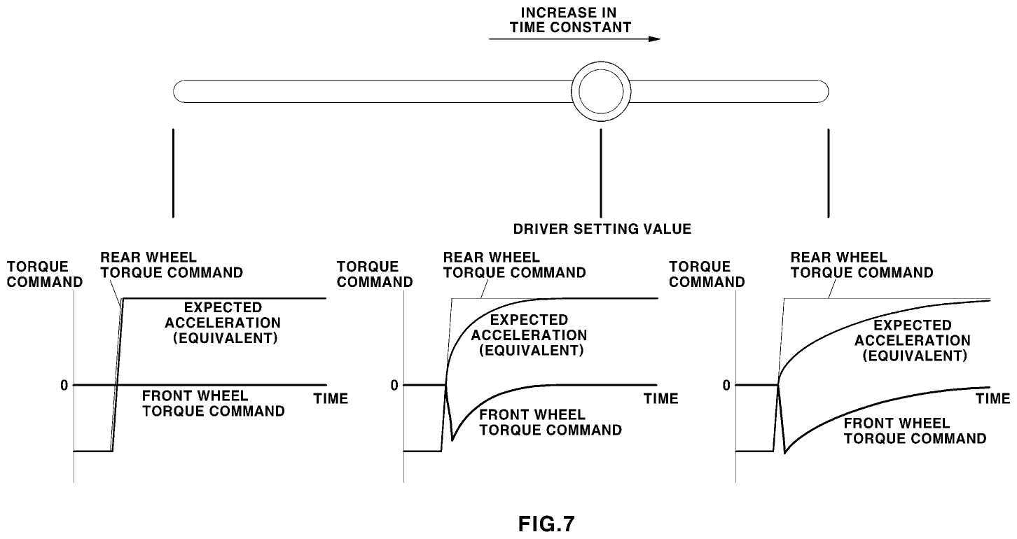

FIG. 7 illustrates a user interface (UI) for setting drift sensitivity in one embodiment, showing how the front and rear wheel torque commands vary with changes in the setting value.

The illustrated embodiment is an embodiment in which correction for the rear wheel torque is not performed during the above-described process of controlling reverse torque distribution between the front and rear wheels, i.e., an embodiment in which correction by adding the absolute value of the reversely distributed torque applied to the front wheel to the distributed torque applied to the rear wheels is not performed during reverse torque distribution between the front and rear wheels.

As shown in FIG. 7, the driver can adjust the setting value by sliding a button on the interface 11 display.

For example, when the button is moved left and right, the UI that may increase or decrease the time constant τ (tau) may be provided. When the button is moved left to decrease the time constant τ (tau) of the low-pass filter (LPF), the magnitude and maintenance time of the reversely distributed torque applied to the front wheels are decreased. On the other hand, when the button is moved right to increase the time constant τ (tau) of the low-pass filter (LPF), the magnitude and maintenance time of the reversely distributed torque applied to the front wheels are increased.

The current position of the button indicates the current driver setting value, and when the time constant of the low-pass filter is changed to the smallest value, the known drift mode, i.e., rear wheel-oriented torque and driving force control in which a motor torque and driving force satisfying the demand torque are applied only to the rear wheels, is performed.

During the rear wheel-oriented torque and driving force control, the motor torque and driving force are not applied to the front wheels, and use of the front wheel drive torque is avoided. However, regenerative braking by the front wheel motor 31 is performed under normal regenerative braking conditions.

In this way, if the known drift mode is executed by adjusting the time constant to the minimum value, a regenerative braking torque by the front wheel motor 31 is not applied to the front wheels during drift driving, and thus, the acceleration responsiveness of the vehicle may be secured. However, while acceleration responsiveness improves, the ease of oversteer initiation remains unchanged.

Conversely, when the time constant of the low-pass filter is changed to the largest value, the drift mode in which extreme torque reverse distribution is performed is executed, and in this case, the regenerative braking torque, which is the reversely distributed torque, is applied to the front wheels during the transient period having the longest time, and specifically, the maximum regenerative braking torque may be applied to the front wheels during the transient period.

Additionally, in an embodiment in which the above-described correction of the rear wheel torque is not performed, since the regenerative braking torque is applied to the front wheels during drift, the acceleration responsiveness of the vehicle is sacrificed (the acceleration responsiveness of the vehicle is reduced).

Instead of accepting sacrifice of the acceleration responsiveness, ease of occurrence of oversteer may be maximized, and even a general driver may easily enter, maintain and control the drift state of the vehicle.

Thus, the drive system torque control apparatus and method for electric vehicles in this disclosure have been detailed. According to the present disclosure, the oversteer behavior of the electric vehicle may be easily generated in the existing drift mode, and oversteer occurrence may be effectively controlled. Particularly, according to the present disclosure, the linear and immediate oversteer behavior of the vehicle may be generated in the drift mode.

In addition, according to the present disclosure, ease of drift, which is a subjective characteristic, may be objectified, and a UI that allows a driver to easily adjust and set the degree of ease of drift to a desired level may be provided. Moreover, the marketability of the electric vehicle may be enhanced.

As is apparent from the above description, an apparatus and method for controlling drift driving of an electric vehicle according to the present disclosure may easily generate the oversteer behavior of the electric vehicle and effectively control occurrence of oversteer in the drift mode of the electric vehicle.

The disclosure has been described in detail with reference to preferred embodiments thereof. However, those skilled in the art will recognize that modifications can be made without departing from the principles and spirit of this disclosure, as defined by the appended claims and their equivalents.

What is claimed is:

1. A drive system torque control apparatus of an electric vehicle comprising:
a controller configured to determine and generate torque commands to apply a driving torque to rear wheels to control the electric vehicle in a drift driving state, based on a demand torque for vehicle driving; and
a front wheel motor and a rear wheel motor each controlled based on the torque commands generated and output by the controller to output torques to drive the electric vehicle in the drift driving state,
wherein the controller:
generates a rear wheel torque command having a torque value in a driving direction for drift driving of the electric vehicle based on the demand torque, and a front wheel torque command having a torque value in a regenerative braking direction opposite to the driving direction; and
controls the electric vehicle to drift via a regenerative braking torque applied by the front wheel motor and the driving torque applied by the rear wheel motor based on the generated front wheel torque command and rear wheel torque command.

2. The drive system torque control apparatus of claim 1, wherein the controller determines a sum of the torque values of the front wheel torque command in the regenerative braking direction and the rear wheel torque command in the driving direction during drift driving of the electric vehicle as a value corresponding to the demand torque.

3. The drive system torque control apparatus of claim 1, wherein the controller:
determines the rear wheel torque command as a torque value in the driving direction corresponding to an accelerator pedal input value depending on operation of an accelerator pedal by a driver from the demand torque determined based on the accelerator pedal input value; and
corrects the determined rear wheel torque command by adding an absolute value of the front wheel torque command to the determined rear wheel torque command, and controls driving of the rear wheel motor with a corrected rear wheel torque command.

4. The drive system torque control apparatus of claim 1, wherein the controller is set to generate the front wheel torque command in the regenerative braking direction for drift driving of the electric vehicle, only when a driver depresses an accelerator pedal and in a transient state where the demand torque is increasing.

5. The drive system torque control apparatus of claim 4, wherein the controller is set to generate only the rear wheel torque command in the driving direction for drift driving of the electric vehicle, when a magnitude of the demand torque is maintained without changing, and to apply torque only to the rear wheels via the rear wheel motor.

6. The drive system torque control apparatus of claim 4, wherein the controller determines the front wheel torque command in the regenerative braking direction as a torque value corresponding to a slope of the demand torque.

7. The drive system torque control apparatus of claim 6, wherein the controller is set to:
determine the torque value of the front wheel torque command as a smaller value as the slope of the demand torque decreases; and
determine the torque value of the front wheel torque command as a larger value as the slope of the demand torque increases.

8. The drive system torque control apparatus of claim 1, wherein the controller is set to determine the front wheel torque command in the regenerative braking direction based on a value derived from applying a low-pass filter or a high-pass filter to the demand torque.

9. The drive system torque control apparatus of claim 8, wherein the controller determines the front wheel torque command as a torque value obtained by subtracting the demand torque from a low-pass filter-applied torque obtained by applying the low-pass filter to the demand torque.

10. The drive system torque control apparatus of claim 9, wherein the controller:
corrects the rear wheel torque command determined from the demand torque by adding a torque value, obtained by subtracting the low-pass filter-applied torque from the demand torque, to the rear wheel torque command; and
controls driving of the rear wheel motor with the corrected rear wheel torque command.

11. The drive system torque control apparatus of claim 8, wherein the controller determines the front wheel torque command as a torque value obtained by multiplying a torque value, obtained by subtracting the demand torque from a high-pass filter-applied torque, obtained by applying the high-pass filter to the demand torque, by −1, or a torque value obtained by subtracting the high-pass filter-applied torque from the demand torque.

12. The drive system torque control apparatus of claim 11, wherein the controller:
corrects the rear wheel torque command determined from the demand torque by adding a torque value, obtained by subtracting the demand torque from the high-pass filter-applied torque, to the rear wheel torque command; and
controls driving of the rear wheel motor with the corrected rear wheel torque command.

13. The drive system torque control apparatus of claim 9, further comprising an interface configured to provide a user interface that allows a user to adjust and set a size or a level of a setting variable configured to determine a magnitude of the regenerative braking torque by the front wheel motor and an application maintenance time of the regenerative braking torque,
wherein the interface is provided to adjust and set a time constant of the low-pass filter or the high-pass filter as the setting variable.

14. The drive system torque control apparatus of claim 1, further comprising an interface configured to provide a user interface that allows a user to adjust and set a size or a level of a setting variable configured to determine a magnitude of the regenerative braking torque by the front wheel motor and an application maintenance time of the regenerative braking torque.

15. A drive system torque control method of an electric vehicle comprising:
determining and generating, by a controller, torque commands to apply a driving torque to rear wheels to control the electric vehicle in a drift driving state based on a demand torque for vehicle driving; and
controlling, by the controller, driving of a front wheel motor and a rear wheel motor to output torques to drive the electric vehicle in the drift driving state depending on the generated torque commands,
wherein the controller:
generates a rear wheel torque command having a torque value in a driving direction for drift driving of the electric vehicle based on the demand torque, and a front wheel torque command having a torque value in a regenerative braking direction opposite to the driving direction; and
controls the electric vehicle to drift via a regenerative braking torque applied by the front wheel motor and the driving torque applied by the rear wheel motor based on the generated front wheel torque command and rear wheel torque command.

16. The drive system torque control method of claim 15, wherein the controller determines a sum of the torque values the front wheel torque command in the regenerative braking direction and the rear wheel torque command in the driving direction during drift driving of the electric vehicle as a value corresponding to the demand torque.

17. The drive system torque control method of claim 15, wherein the controller:
determines the rear wheel torque command as a torque value in the driving direction corresponding to an accelerator pedal input value depending on operation of an accelerator pedal by a driver from the demand torque determined based on the accelerator pedal input value; and
corrects the determined rear wheel torque command by adding an absolute value of the front wheel torque command to the determined rear wheel torque command, and controls driving of the rear wheel motor with a corrected rear wheel torque command.

18. The drive system torque control method of claim 15, wherein the controller is set to generate the front wheel torque command in the regenerative braking direction for drift driving of the electric vehicle, only when a driver depresses an accelerator pedal and in a transient state where the demand torque is increasing.

19. The drive system torque control method of claim 18, wherein the controller is set to generate only the rear wheel torque command in the driving direction for drift driving of the electric vehicle, when a magnitude of the demand torque is maintained without changing, and to apply torque only to the rear wheels via the rear wheel motor.

20. The drive system torque control method of claim 15, wherein the controller is set to determine the front wheel torque command in the regenerative braking direction based on a value derived from applying a low-pass filter or a high-pass filter to the demand torque.
